(19) United States
(12) Patent Application Publication
(10) Pub. No.: US 2012/0272486 A1
(43) Pub. Date: Nov. 1, 2012

(54) Zip Tie Nail and Screw Fasteners

(76) Inventors: James Murphy, Fleming Island, FL (US); Bruce Scott, Mountain View, CA (US)

(21) Appl. No.: 13/458,440

(22) Filed: Apr. 27, 2012

Related U.S. Application Data
(60) Provisional application No. 61/481,058, filed on Apr. 29, 2011.

(51) Int. Cl. B65D 63/00; F16B 35/00; F16B 1/00

(52) U.S. Cl. 24/16 R; 24/591.1; 411/388

(57) ABSTRACT

A fastener system comprising a zip tie and a screw, nail, pin, or the like, is presented. The screw, nail, or pin has at least one through hole configured to receive the zip tie. Together, the zip tie and the screw, nail, or pin provide a fastening system that can be used in numerous applications. In some embodiments, the through hole includes a pawl configured to engage a toothed portion of the zip tie.

This application claims the benefit of priority to U.S. provisional application Ser. No. 61/481058, filed on Apr. 29, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is fasteners.

### BACKGROUND

Numerous zip tie fasteners are known in the art and generally comprise a flexible elongated member having a plurality of teeth and a pawl configured to engage the teeth. See, for example: U.S. Pat. No. 3,766,608, U.S. Pat. No. 4,347,648, U.S. Pat. No. 4,617,702, U.S. Pat. No. 4,754,529, U.S. Pat. No. 6,332,248, U.S. Pat. No. 6,347,435, U.S. Pat. Nos. 6,508,355, 6704972, US20070234524, US20080184538, and http://www.homedepot.com/webapp/wcs/stores/servlet/Search?keyword=zip+tie&langId=−l&storeId=10051&catalogId=10053.

Zip tie fasteners have numerous applications, such as bundling cables or fastening two separate members together. It would be advantageous to provide a nail, screw, pin, or similar fastener, which is capable of securely receiving a zip tie fastener.

### SUMMARY OF THE INVENTION

The inventive subject matter provides apparatus, systems and methods in which a fastener system includes: (i) a first elongated member that has a toothed portion and a pawl configured to releasably and securely engage the toothed portion; and (ii) a second elongated member that has a through hole configured to receive the first elongated member. The through hole can also be configured with a pawl configured to engage the toothed portion.

In some embodiments, the first elongated member is a conventional zip tie. In other aspects of some embodiments, the second elongated member comprises a screw, nail, pin, or similar fastener.

In yet other embodiments, the zip tie is made of a flexible material such as plastic. In other aspects of some embodiments, the second elongated member is made of a rigid material, such as wood, metal, and hard plastics and composites.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of one embodiment of a clevis pin.

FIG. 2 is a perspective view of one embodiment of a pedicle screw.

FIG. 3 is a perspective view of one embodiment of a loop-screw.

FIG. 4 is a perspective view of one embodiment of a zip tie screw.

FIG. 5 is a perspective view of another embodiment of a zip tie screw.

FIG. 6 is a perspective view of one embodiment of a zip tie nail.

FIG. 7 is a perspective view of another embodiment of a zip tie nail.

FIG. 8 is a perspective view of a fastener system comprising a zip tie and a zip tie screw.

FIG. 9 is a close-up perspective view of a pawl of a zip tie screw.

FIG. 10 is a perspective view of one embodiment of a zip tie nail that has two through holes.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

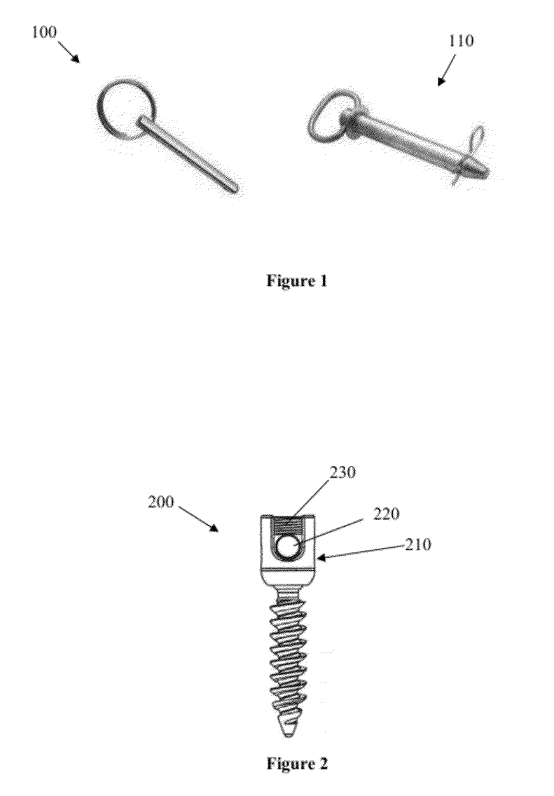

FIG. 1 shows two conventional “clevis pins” (pin 100 and pin 110). Pin 100 and pin 110 each have a through hole at one of their ends for receiving a ring. Unfortunately, these holes are not well suited for receiving zip ties. For example, the holes are too small to receive conventional zip tie sizes. In addition, the holes' cross sections are not shaped and configured to securely and snugly receive a zip tie.

FIG. 2 shows a pedicle screw 200 used for spinal fixation, as taught in US Patent Application Publication No. S 2010/0312288 to Hammill. Pedicle screw 200 has a head 210 configured to receive a rod 220. Set screw 230 is used to secure rod 220 to head 210. Head 210 and set screw 230 are not well suited for receiving a zip tie in a slidable fashion.

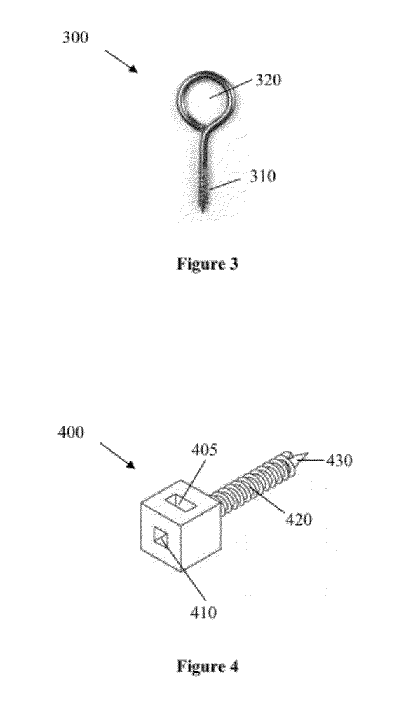

FIG. 3 shows a conventional “loop-screw” (loop screw 300). Loop screw 300 has a threaded end 310 and a looped end that defines opening 320. Opening 320 is large enough to receive a conventional zip tie fastener. Unfortunately, opening 320 is well suited for receiving a zip tie fastener in a secure manner. For example, the size, shape, depth, and other various characteristics of opening 320 have not been specifically chosen to securely and snugly receive a zip tie fastener.

FIGS. 1-3 demonstrate that, while it is known to include holes in the sides of screws, nails, pins, and the like, those of ordinary skill in the art have failed to appreciate that a fastener system could include a zip tie and a screw, nail, pin, etc. with a hole especially configured to receive the zip tie in a secure and snug manner.

FIG. 4 shows a zip tie screw 400. Screw 400 is an elongated member that has a first end (i.e., pointed end 430) and a second end (i.e., a cube-shaped head). Screw 400 also has a spiral grooved portion 420. Both portion 420 and end 430 are configured to penetrate into a substrate when screw 400 is rotated. Screws are well known and portion 420 and end 430 can have numerous configurations depending on the substrate to be penetrated and the particular application (e.g., environment conditions, etc). Screw 400 can be made of any material having mechanical properties suitable for the application. In some embodiments screw 400 has a zinc plated finish. In some embodiments, screw 400 is made of a rigid material.

The cube-shaped head of screw 400 has a rectangular-shaped zip tie opening 405 for receiving a zip tie. Opening 405 is a through hole that passes through the other side of the cube-shaped head. Opening 405 is specifically configured with a width, length, depth, cross sectional shape, and inner surface finish such that opening 405 slidably receives a particular size and type of a zip tie fastener. The cross sectional shape of opening 405 matches the shape of a zip tie fastener to be used with screw 400. Once the zip tie fastener is fed through opening 405, screw 400 will not easily rotate about the length of the zip tie. Those of skill in the art will appreciate that the exact size, dimension, and other characteristics of opening 405 can vary depending on the intended application and the type of zip tie fastener to be used with screw 400, without departing from the inventive concepts disclosed herein. In alternative embodiments, opening 405 can be configured such that screw 400 is allowed to easily rotate about the length of the zip tie fastener.

The top of the cube-shaped head has a tool hole 410, which is shaped and configured to engage a tool such as an allen wrench or screw driver. While tool hole 410 is shown having a rectangular shape, tool hole 410 can be configured with any shape suitable for engaging a tool. Other possible shapes include, but are not limited to, hexagons, regular polygons, irregular polygons, and slots. It is further contemplated that tool hole 410 can be a protrusion rather than a hole.

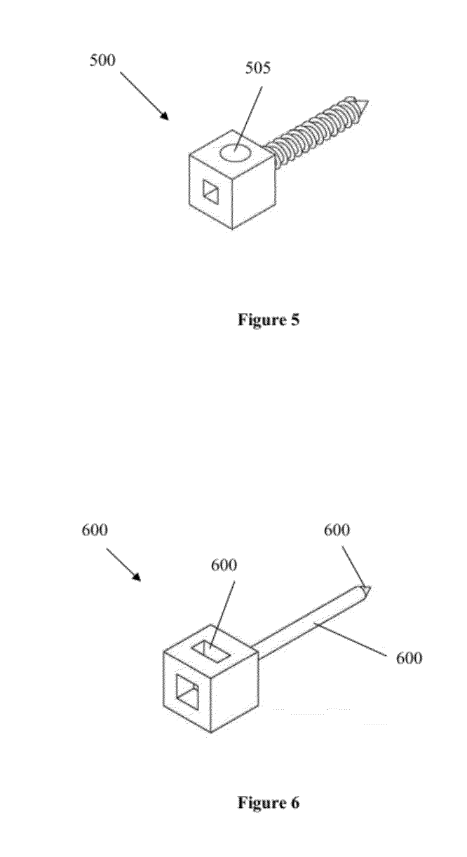

FIG. 5 shows another embodiment of a zip tie screw, namely screw 500. Screw 500 is similar to screw 400 except that it has a circular opening 505 rather than a rectangular opening 405. The circular shape of opening 505 facilitates the machine manufacture of a zip tie screw. One of skill in the art will appreciate that shapes other than circles and rectangles can be used as openings for receiving zip tie fasteners. The shape of the zip tie opening can be designed and chosen based on various factors such as cost, esthetics, manufacturability, and ability to engage a tool.

FIG. 6 shows one embodiment of a zip tie nail, namely nail 600. Nail 600 is similar to screw 400 except that it lacks a grooved portion 420. Nail 600 is designed for use in applications that would require a nail. The top of the head of nail 600 is substantially flat and provides a striking surface for a hammer. Nail 600 could alternatively be configured to work with a nail gun.

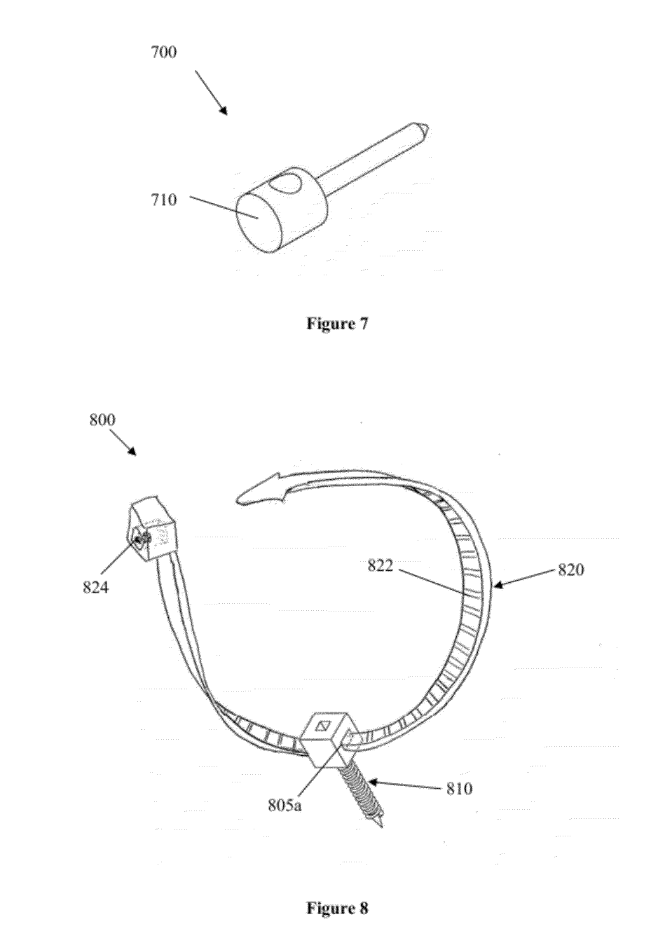

FIG. 7 shows a zip tie nail 700, which is similar to nail 600 except that it has a cylindrical head 710 rather than a cube-shaped head and lacks a hole for engaging a tool. The diameter of head 710 is larger than the diameter of the remaining portion of nail 700. One of skill in the art will appreciate that head shapes other than rectangular, cubed, or cylindrical can be used consistently with the inventive subject matter discussed herein. For example, other shapes can include hexagons, spheres, pyramids, triangular prisms, diamonds, heart-shapes, cones, parallelograms, regular polygons, and irregular polygons. Alternatively, nail 700 could lack any distinguishable “head” portion (e.g., the first end, second end, and the body of nail 700 could have the same cross sectional size and shape).

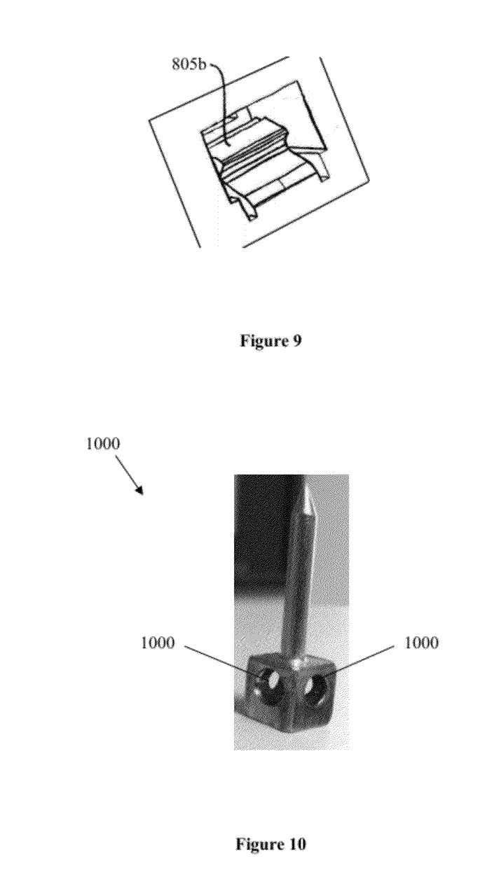

FIG. 8 shows a fastener system 800 comprising: (i) a zip tie screw 810, and (ii) a zip tie 820. Screw 810 is similar to screw 400 of FIG. 4. Zip tie 820 is a common zip tie having a toothed portion 822 and a pawl 824 configured to engage the toothed portion 822, such as is taught in U.S. Pat. No. 4,754,529. A close-up view of a pawl is shown in FIG. 9. As used herein, a “pawl” refers to any structure suitable for releasably engaging protrusions or teeth. Variations from conventional zip tie pawls and zip tie teeth can be used consistently with the inventive concepts disclosed herein, as long as the zip tie variation provides a releasable engagement. In alternative embodiments, the zip tie is a length of a hook-and-loop fastener.

Fastener system 800 can be used in numerous applications. For example, zip tie 820 can be used to bundle cables together and screw 810 can be used to fasten the bundle to a ceiling. In another application, zip tie 820 can be fastened to the frame of a bicycle and screw 810 can be used to secure the bicycle to a wall.

Opening 805a of screw 810 is similar to opening 405 of screw 400 in FIG. 4. In alternative embodiments, opening 805a is modified, as shown in FIG. 9. FIG. 9 shows a close-up view of an opening 805b, which has a pawl disposed on its inner surface and configured to releasably engage toothed portion 822. In such embodiments, screw 810 can be temporarily secured and/or mobilized with respect to zip tie 820.

FIG. 10 shows another embodiment of a zip tie nail. Nail 1000 has a first opening 1010 and a second opening 1020 that intersect with one another. Openings 1010 and 1020 allow for a zip tie to be fed into the head of nail 1000 in different configurations. In one configuration, a first zip tie is fed through opening 1010 and a second zip tie is fed through opening 1020 such that the zip ties overlap each other. In other configuration, a first zip tie is fed through the opening 1010 and exits opening 1020 such that it bends 90 degrees as it passes through the head of nail 1000. Those of skill in the art will appreciate that any number of through holes can be included on a nail or screw for receiving a zip tie. The through holes can be linear or non-linear and can even be located at different points along the length of the elongated member (e.g., through the grooved portion 420 of screw 400).

While the embodiments described above are directed at screws, nails, and pins, the present inventive subject matter is not intended to be limited by such applications and devices. Those of skill in the art will appreciate that the inventive subject matter can be used with any elongated fastener that can accommodate a through hole.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A fastener system comprising;
a first elongated member comprising a toothed portion and a first pawl configured to engage the tooth portion; and
a second elongated member having a first end, a second end, and a first through hole extending through the elongated member; and
wherein the first through hole is configured to receive the toothed portion of the first elongated member.

2. The fastener system of claim 1, further comprising a second pawl disposed on an inner surface of the first through hole.

3. The fastener system of claim 2, wherein the second pawl is configured to engage the toothed portion.

4. The fastener system of claim 1, wherein the first end forms a point.

5. The fastener system of claim 1, wherein the second elongated member comprises a spiral grooved portion.

6. The fastener system of claim 1, wherein the first elongated member comprises plastic.

7. The fastener system of claim 1, wherein the second elongated member comprises metal.

8. The fastener system of claim 1, wherein the first through hole is disposed on the second end of the second elongated member.

9. The fastener system of claim 8, wherein the second end is cube-shaped.

10. The fastener system of claim 8, wherein the second end is cylindrical-shaped and has a larger radius than the radius of the cylindrical member.

11. The fastener system of claim 1, wherein the first through hole is substantially linear.

12. The fastener system of claim 1, wherein the first through hole is substantially non-linear and comprises a 90 degree bend.

13. The fastener system of claim 1, further comprising a second through hole disposed on the second elongated member such that it intersects the first through hole.

14. The fastener system of claim 1, wherein an inner surface of the second through hole includes a pawl configured to engage the toothed portion of the first elongated member.

15. The fastener system of claim 1, wherein the first elongated member comprises a third through hole.

16. The fastener system of claim 15, wherein the first pawl is disposed on an inner surface of the third through hole.

17. The fastener system of claim 1, wherein at least part of the toothed portion is disposed in the first through hole.

18. The fastener system of claim 1, wherein the first elongated member is flexible.

19. The fastener system of claim 18, wherein the second elongated member is rigid.
